(19) United States
(12) Patent Application Publication
(10) Pub. No.: US 2013/0089850 A1
(43) Pub. Date: Apr. 11, 2013

(54) Method and Tool to Assess the Vitality of Technical Communities of Practice

(71) Applicants: Margaret A. Strong, Spicewood, TX (US); Wendy K. Hughes, Central Islip, NY (US); Shane D. Gerson, Wellesley, MA (US)

(72) Inventors: Margaret A. Strong, Spicewood, TX (US); Wendy K. Hughes, Central Islip, NY (US); Shane D. Gerson, Wellesley, MA (US)

(73) Assignee: Computer Associates Think, Inc.

(21) Appl. No.: 13/270,615

(22) Filed: Oct. 11, 2011

(51) Int. Cl. G09B 7/00

(52) U.S. Cl. 434/362

(57) ABSTRACT

A system and method is provided for assessing a technical community. A plurality of characteristics that each describe an aspect of the technical community may be retrieved. An interface that displays the plurality of characteristics as queries to be answered by a member of the technical community may be generated. An input for each characteristic may be received, wherein each input comprises a quantitative input that provides a qualitative opinion of the member of the technical community for a corresponding characteristic. A score based on at least one input may be generated. The score may provide the assessment of the technical community.

### TECHNICAL FIELD

The invention relates to the field of analyzing technical communities. More particularly, the invention relates to a quantitative approach for analyzing/assessing technical communities.

### BACKGROUND

Technical communities of practice have seen increased popularity in the past ten years due to their numerous benefits. Technical communities provide a collective technical brain trust to solve critical business needs and support initiatives; collect and codify intellectual capital; assemble technical talent on a common platform across corporate silos; efficiently distribute emerging knowledge through the community social fabric; mobilize members quickly to respond to customer needs, ferret out unique responses to proposals and other knowledge inquiries, external channels and customers; provide support and mentoring for new hires and acquisitions; address attrition by providing a support and mentoring network; and prevent institutional brain drain by providing retirees access for mentoring and skilling-up.

Consequently, innovative organizations have made major investments in growing and maintaining their technical community of practice programs. A vibrant technical community requires considerable investment such as: providing an engaging online collaborative platform embedded with features to drive knowledge transfer, defining roles, dedicating executive sponsorship, and fostering an active membership that is either willing to volunteer or having allocated time to participate. The costs can add up, and technical communities must be prepared to provide a value, often numerative, to justify the investment. Because these technical communities engage talent and company resources directly involved in the revenue stream, there is a need to assess them for their usefulness and vitality before they become neglected.

Conventionally, return on investment studies have probed soft features of the community and occur at a point in the technical community lifecycle when a “go/no go” decision is at hand. Existing methods call on anecdotal evidence as the primary method of assessing technical community vitality. Also, the methods utilize qualitative measures based upon the output of interviews and focus groups, and descriptive metrics (number of visits, discussion threads, etc.) to analyze technical communities or monitor community value. One method for analyzing technical communities includes social network analysis (SNA). SNA is an ex post facto method of spotting central nodes of communication within a community using historical data. Patterns of communication exposed through SNA can indicate whether a technical community is sized or linked correctly.

However, there is a need for a comprehensive, quantitative approach to analyze/assess technical communities and provide recommendations for remediating technical communities' shortcomings in order to optimize its presence and value in a technical enterprise.

These and other drawbacks exist.

### SUMMARY

Various systems, computer program products, and methods for assessing a technical community are described herein.

According to various implementations of the invention, the method may include a plurality of operations. In some implementations, the operations may include retrieving, by a processor, a plurality of characteristics that each describe an aspect of the technical community, the technical community comprising a group of members that share expertise regarding a technical subject, wherein the plurality of characteristics are collectively used to assess the technical community. In some implementations, the operations may include, generating, by the processor, an interface that displays the plurality of characteristics as queries to be answered by a member of the technical community. In some implementations, the operations may include receiving, by the processor, an input for each characteristic, wherein each input comprises a quantitative input that provides a qualitative opinion of the member of the technical community for a corresponding characteristic. In some implementations, the operations may include generating, by the processor, a score based on at least one input, wherein the score provides the assessment of the technical community.

### BRIEF DESCRIPTION OF THE DRAWINGS

The accompanying drawings, which are incorporated into and constitute a part of this specification, illustrate one or more examples of implementations of the invention and, together with the description, serve to explain various principles and aspects of the invention.

FIG. 1 illustrates an exemplary system 100 for assessing a technical community, according to various aspects of the invention.

FIG. 2 illustrates exemplary characteristics associated with a technical community, according to various aspects of the invention

FIG. 3 illustrates an exemplary relationship between technical community lifecycle and assessment tool, according to various aspects of the invention.

FIG. 4 illustrates an interface generated by community management system, according to various aspects of the invention.

FIG. 5 is a flowchart depicting example operations performed by the community management system, according to various aspects of the invention.

Reference will now be made in detail to various implementations of the invention as illustrated in the accompanying drawings. The same reference indicators will be used throughout the drawings and the following description to refer to the same or like items.

### DESCRIPTION OF EXEMPLARY IMPLEMENTATIONS

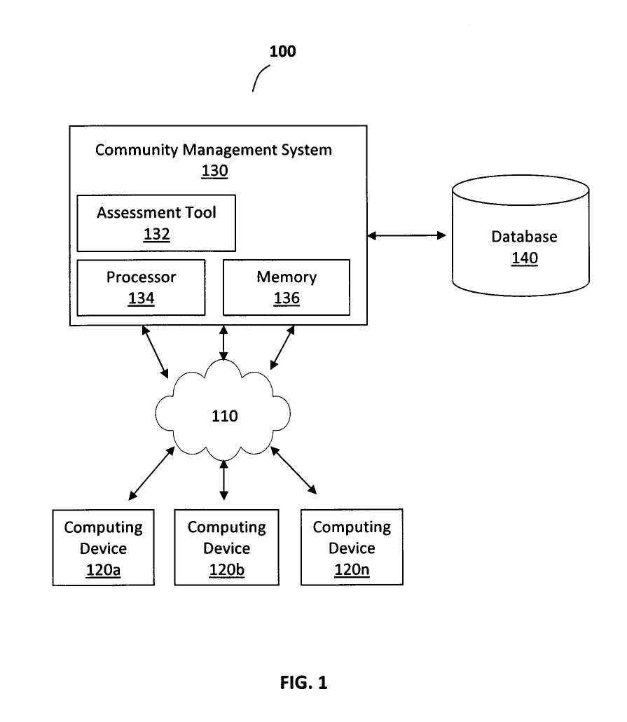

FIG. 1 is a block diagram illustrating a system 100, according to an aspect of the invention. System 100 may include, among other things, at least a community management system 130 that is configured to manage one or more technical communities. A technical community may comprise a group of members that share expertise regarding a particular technical subject. The members of the technical community may communicate via electronic communication mechanisms, such as teleconferences, web-based meetings, discussion forums, chat rooms, etc. In some implementations, members may communicate via in-person meetings. In some implementations, community management system 130 may be configured to manage the electronic communications. A technical community may be determined as being an effective technical community if the community knows when to retire or splinter into different groups that may be more relevant for a future need.

Community management system 130 may include, among other components, assessment tool 132, processor 134, and/or memory 136. Assessment tool 132 may be configured to assess the one or more technical communities. Community management system 130 may be communicatively coupled to database 140. Community management system 130 may be communicatively coupled to a computing device 120 (illustrated in FIG. 1 as a plurality of computing devices 120a . . . 120n). Community management system 130 may be coupled to computing device 120 via a network 110. Network 110 may include a Local Area Network, a Wide Area Network, a cellular communications network, a Public Switched Telephone Network, and/or other network or combination of networks.

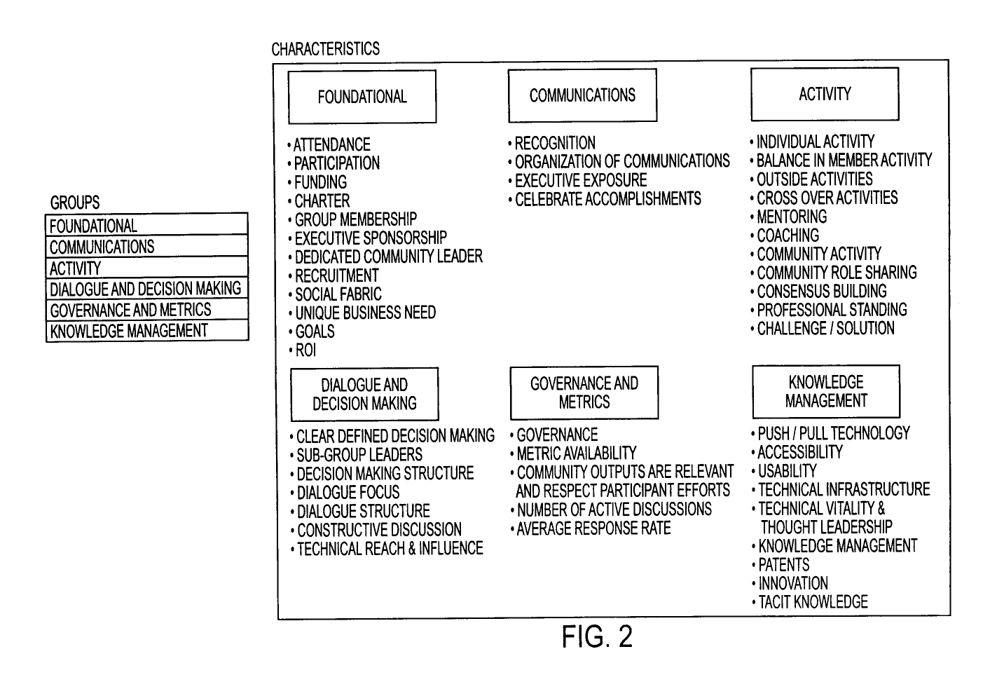

In some implementations, a plurality of characteristics may be defined that each describe an aspect of the technical community. FIG. 2 illustrates exemplary characteristics associated with a technical community. As illustrated in FIG. 2, fifty characteristics may be grouped into six groups, namely, foundational, communications, activity, dialogue and decision making, governance and metric, and knowledge management. In some implementations, the characteristics may be collectively used to assess the technical community. It will be understood that the characteristics and groups depicted in FIG. 2 are exemplary and any number and type of characteristics and groups may be used to assess a technical community, without departing from the scope of this disclosure.

In some implementations, the characteristics and groups may be customized. For example, a set of characteristics may be better suited to assess a first technical community, whereas another set of characteristics may be better suited to assess a second technical community.

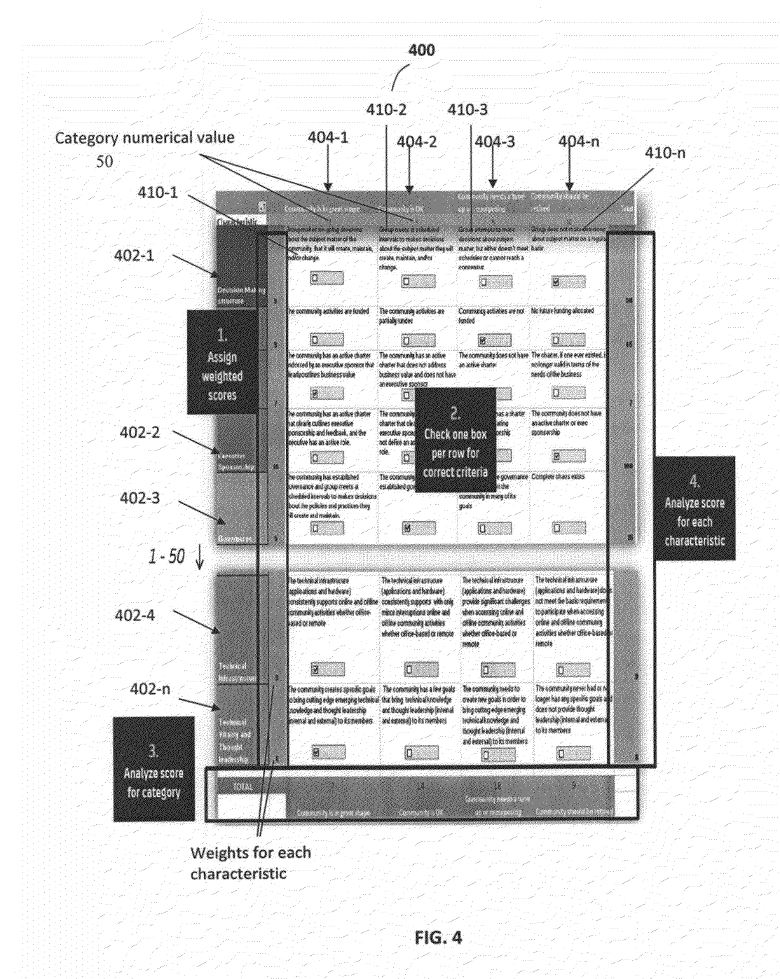

In some implementations, a plurality of categories may be defined that each indicate a condition of the technical community. For example, as depicted in FIG. 4, a first category may indicate that the “community is in great shape,” a second category may indicate that the “community is OK,” a third category may indicate that the “community needs a tune up or repurposing,” and a fourth category may indicate that the “community should be retired.” It will be understood that the categories described herein are exemplary and any number and type of categories may be used to assess a technical community, without departing from the scope of this disclosure.

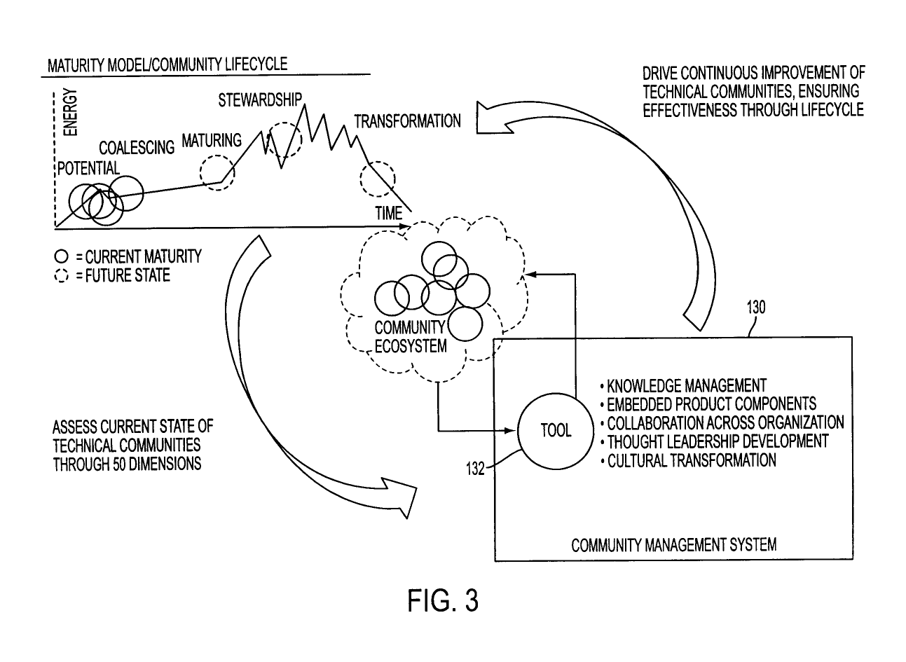

In some implementations, technical communities may have a predictable community lifecycle, as shown in FIG. 3. In other words, technical communities may encounter predictable stages during their lifecycle. These stages are not linked to a timeline and technical communities may develop at different rates, although the lifecycle pattern can be traced through almost all technical communities. Various stages such as, for example, Potential, Coalescing, Maturing, Stewardship, and Transformation, are illustrated in the graph titled, “Maturity Model/Community Lifecycle” of FIG. 3. In some implementations, the Potential stage may address the capability of what the technical community can become, understanding the initial needs with a focus on discovery and imagining. In some implementations, the technical community is in a Coalescing stage when ideas incubate and start to come together. In some implementations, as the technical community matures, it enters a Maturing stage. In the Maturing stage the technical community may expand into a fully developed entity that is focused on the technical need that initiated its genesis. In some implementations, the Stewardship stage ensures that the technical community maintains a sense of ownership and openness to drive effective thought leadership and collaboration. In some implementations, the Transformation stage supports and reinforces the changes or new ideas that are introduced into the organization from the technical community. The length of time that each community takes to get to these stages varies. For example, one technical community may be in a Coalescing stage whereas another technical community may be in a Maturing stage. Each solid ring in the graph of FIG. 3 depicts a different technical community associated with an organization. In particular, the solid rings indicate that the different technical communities illustrated in FIG. 3 are in the Potential and Coalescing stages. The dotted line circles in the graph of FIG. 3 indicate a projected path that a particular technical community would take as it progresses forward (i.e., through its lifecycle).

The community ecosystem may include a plurality of technical communities associated with a business/organization. For example, each circle/ring in the community ecosystem cloud illustrated in FIG. 3 may represent a technical community. The community ecosystem may be an environment that fosters a system of technical communities that are created to add value and address technical needs within the organization. Each technical community may reside within the system and have its own goals and focus areas. The community ecosystem pulls through the community lifecycle organically with no existing method to promote or recognize divergence from best practices. In some implementations, assessment tool 132 may be configured to identify where a particular technical community is in the lifecycle, assess the technical community, and/or provide remediation by highlighting opportune areas of improvement, thereby facilitating continuous improvement and value to business.

In some implementations, community management system 130 may leverage the technical communities to promote knowledge management, new product enhancements, collaboration across the organization, thought leadership development, and/or cultural transformation. Knowledge management may refer, to the sharing of insights, expertise and experiences across the technical community. This would be prevalent in a skill-based community where focus is on a specific domain (range of personal knowledge) or skill set. If the focus of the community is product oriented or product based, the community is an effective way to generate concepts for new product enhancements that can be embedded into existing products (embedded product components). In some implementations, assessment tool 132 may be included into existing technical products that leverage from a technical community based approach. The community may foster the promotion of new, innovative ideas that enable strategy and visionary solutions (thought leadership development). Without a technical community often thought provoking ideas are never heard. The community may promote a sense of belonging and is an enabler of driving effective behaviors across an organization through collaboration and the reinforcement of sharing ideas (cultural transformation).

In some implementations, assessment tool 132 may assess the current state of a technical community (i.e., current stage of technical community in the lifecycle) based on the plurality of characteristics. FIG. 3 also depicts the potential of moving a group of latent technical communities to more contributory phases in the lifecycle (shown as dotted line circles in FIG. 3 under “Maturity Model/Community Lifecycle”). In some implementations, a determination regarding which technical community has a potential of moving to a more contributory phase may be made based on the assessment determined by assessment tool 132. In some implementations, a determination regarding whether the technical community is an effective technical community may be made based on the assessment determined by assessment tool 132.

In some implementations, assessment tool 132 may use the plurality of characteristics to determine a score that indicates the condition of the community and determine prescriptive remediation and/or recommendations for remediating technical communities' shortcomings. In some implementations, assessment tool 132 may be coupled to various collaboration or social networking applications to deliver maximum value to business. In some implementations, assessment tool 132 may be used to assess the value of a technical community for marketing, business analysis, or inter-community comparisons in internal/external cloud or cloud domains. In some implementations, the framework of assessment tool 132 may be interoperable and multiplatform.

In some implementations, community management system 130 may include a processor 134, a memory 136, and/or other components that facilitate the functions of community management system 130. In some implementations, processor 134 includes one or more processors configured to perform various functions of community management system 130. In some implementations, memory 136 includes one or more tangible (i.e., non-transitory) computer readable media. Memory 136 may include one or more instructions that when executed by processor 134 configure processor 134 to perform functions of community management system 130. In some implementations, memory 136 may include one or more instructions stored on tangible computer readable media that when executed at a remote device, such as computing device 110, cause the remote device to view, retrieve, edit, and/or otherwise interact with information associated with characteristics/categories associated with the technical communities, as described herein.

Users, including but not limited to, members of the technical community, moderators/facilitators for the technical community, and/or other users may interact with community management system/assessment tool 132 via computing device 120. In some implementations, computing device 120 may include a computing/processing device such as a desktop computer, a laptop computer, a network computer, a wireless phone, a personal digital assistant, a tablet computing device, workstation, and/or other computing devices that may be utilized to interact with community management system 130/assessment tool 132. In some implementations, computing device 120 may comprise a user interface (not otherwise illustrated in FIG. 1) that allows users to perform various operations that facilitate interaction with community management system 130/assessment tool 132 including, for example, providing requests to retrieve information associated with the plurality of characteristics, displaying the plurality of characteristics, providing inputs associated with the plurality of characteristics, displaying reports, and/or performing other operations. Computing device 120 may include a processor (not otherwise illustrated in FIG. 1), circuitry, and/or other hardware operable to execute computer-readable instructions.

In some implementations, assessment tool 132 may retrieve a plurality of characteristics that each describe an aspect of the technical community. In some implementations, assessment tool 132 may retrieve the characteristics depicted in FIG. 2, for example. In some implementations, assessment tool 132 may retrieve the characteristics in response a request (for example, a user request or other request). In some implementations, the request may identify the technical community to be assessed. In some implementations, in response to the request, assessment tool 132 may retrieve the characteristics that are to be used to assess the identified technical community. In some implementations, assessment tool 132 may retrieve the characteristics by querying database 140. In these implementations, the characteristics may be stored using database 140.

In some implementations, assessment tool 132 may generate an interface 400 that displays the plurality of characteristics as queries to be answered by a member of the technical community, as shown in FIG. 4, for example. In some implementations, assessment tool 132 may generate a tabular representation that displays the plurality of characteristics. For example, FIG. 4 depicts characteristics 402-1, 402-2, 402-3, 402-4 . . . 402-n and categories 404-1, 404-2, 404-3 . . . 404-n in a tabular representation. As illustrated, the characteristics may be represented as rows and categories as columns.

In some implementations, assessment tool 132 may assign a weight to each of the plurality of characteristics. In some implementations, assessment tool 132 may generate an interface that allows a user to assign the weight to each characteristic. In some implementations, the assigned weights may be customized. For example, the user may assign the weight according to the relevance or priority of a corresponding characteristic for the technical community. In some implementations, a characteristic may be assigned a weight in the range of 1-10, wherein weight “1” may indicate a lowest weight, and weight “10” may indicate a highest weight. In some implementations, a higher weight may be assigned to a characteristic that is relatively more important than another characteristic (which would be assigned a lower weight). For example, characteristic 402-1 “Decision Making structure” may have a weight “5” assigned to it. Characteristic 402-2 “Executive Sponsorship” may have a weight “10” assigned to it. Characteristic 402-3 “Governance” may have a weight “5” assigned to it. Characteristic 402-4 “Technical Infrastructure” may have a weight “9” assigned to it. Characteristic 402-n “Technical Vitality and Thought Leadership” may have a weight “8” assigned to it. In some implementations, assessment tool 132 may retrieve the characteristics and the associated weights from database 140. As would be appreciated, the foregoing weights are non-limiting examples; other weights and meanings/values of weights may be used according to particular needs.

In some implementations, assessment tool 132 may assign a numerical value to each category of a plurality of categories. In some implementations, the numerical value for each category may be a static pre-defined value. In some implementations, the numerical value may be assigned by the moderator/facilitator of the technical community. For example, category 404-1 “Community is in great shape” may have a numerical value “1” assigned to it. Category 404-2 “Community is OK” may have a numerical value “3” assigned to it. Category 404-3 “Community needs a tune up or repurposing” may have a numerical value “5” assigned to it. Category 404-n “Community should be retired” may have a numerical value “10” assigned to it. In some implementations, assessment tool 132 may retrieve the categories and their associated numerical values from database 140.

In some implementations, interface 400 may display each characteristic in a multiple-choice answer format. In some implementations, for each characteristic, interface 400 may display four possible choices from which a member may select (in the form of check boxes, for example). In some implementations, interface 400 may display a description (410-1, 410-2, 410-3 . . . 410-n) of each multiple-choice answer. In some implementations, each description may describe a qualitative opinion of the member regarding the condition of the technical community (i.e., the category that the community falls under). In some implementations, each description (410-1, 410-2, 410-3 . . . 410-n) may describe a qualitative opinion of the member of the technical community for a corresponding characteristic 402-1. Similarly, various multiple choice answers and associated descriptions may be provided for characteristics 402-2, 402-3, 402-4 . . . 402-n. In some implementations, each characteristic 402-1 may be associated with its own description, which may be unique or shared with other characteristics.

In some implementations, assessment tool 132 may receive an input for each characteristic. In some implementations, each input may comprise a quantitative input that provides a qualitative opinion of the member of the technical community for the corresponding characteristic. In some implementations, each multiple choice answer may be representative of the quantitative input. For example, as shown in FIG. 4, a member may have selected the check box associated with category 404-n for characteristic 402-1. In other words, out of the four possible choices for characteristic 402-1 “Decision Making Structure,” a member may select the answer associated with a qualitative description that the “Group does not make decisions about subject matter on a regular basis” with respect to category 404-n. The selected answer may in turn be associated with “Community should be retired.” This selection may indicate that, in the member's qualitative opinion, the technical community “group does not make decisions about subject matter on a regular basis,” as indicated by description 410-n. In some implementations, assessment tool 132 may receive, as input, a selection of the numerical value associated with each category. For example, selection of the answer associated with category 404-n may cause a selection of numerical value “10” associated with category 404-n. In some implementations, the numerical value associated with category 404-n may correspond to the quantitative input for characteristic 402-1. In some implementations, the input associated with a characteristic may align to a numerical value associated with a category and a characteristic weight.

In some implementations, assessment tool 132 may generate a score based on at least one input received from the member of the technical community. In some implementations, the score may provide an assessment of the technical community.

In some implementations, the score may include a characteristic score for each characteristic. In some implementations, the characteristic score for a particular characteristic may be based on the input received for that characteristic. In some implementations, the characteristic score, for each characteristic, may be based on the weight associated with the characteristic and the numerical value associated with the selected category. In some implementations, the characteristic score may be generated based on the following formula:

Characteristic Score=Category numerical value*Characteristic weight

For example, the rightmost column in FIG. 4 depicts the characteristic scores for each characteristic. In particular, as illustrated in FIG. 4, the characteristic score for characteristic 402-1 is determined by multiplying 10 (the category numerical value) with 5 (characteristic weight) which equals 50 (characteristic score). Characteristic scores for each characteristic may be determined in a similar manner.

In some implementations, the characteristic score may provide an assessment of the technical community according to the corresponding characteristic. In some implementations, the characteristic score for a characteristic may provide an indication of how well the technical community performs in a particular area. For example, a score of “15” for characteristic 402-3 may indicate that the technical community is performing well in the governance area, whereas, a score of “100” for characteristic 402-2 may indicate that the technical community is not performing well in the executive sponsorship area. As would be appreciated, the relative weights and quantitative values may be different such that a higher score indicates better performance than a lower score.

In some implementations, assessment tool 132 may analyze the score for each characteristic to identify areas of improvement for the technical community. For example, based on the above example, a determination may be made that improvement may be necessary in the executive sponsorship area. In some implementations, assessment tool 132 may generate recommendations for remediating technical communities' shortcomings in areas where improvement may be necessary.

In some implementations, assessment tool 132 may generate a category score based on a collection of each of the inputs received from the member of the technical community. For example, the bottom row in FIG. 4 depicts the category scores for each category. In some implementations, assessment tool 132 may determine a category score for each category. In some implementations, the category score for a category may be determined by adding the number of inputs received for that category. For example, the category score for category 404-1 is “7”, which indicates that a member selected 7 check boxes for category 404-1 (i.e., selected category 404-1 for 7 characteristics). Category scores for the other categories may be similarly determined. In some implementations, assessment tool 132 may analyze the category score to determine an overall state of the technical community. In some implementations, the number of selected check boxes may indicate which category the technical community is in, thereby categorizing the community according to various categories such as, for example, “in great shape”, “OK”, “needs a tune up or repurposing”, or “should be retired”. A number of selected check boxes per category may provide the community owner with a suggested direction and action that can be taken for the respective community.

In some implementations, assessment tool 132 may further analyze the distribution of the values (i.e., category scores). For example, category 404-3 and 404-2 may have higher scores of 18 and 14, respectively, and category 404-n and 404-1 may have lower scores of 9 and 7, respectively. As such, assessment tool 132 may make a determination that the community “needs a tune up or repurposing” because the category 404-3 has the highest score. However, after addressing the poorer performing characteristics with the highest characteristic scores (e.g., executive sponsorship 404-2 with a score of “100” and decision making structure 402-1 with a score of “50”), the community might be assessed as “OK” and/or determined to be an effective community. This may be implied because the second highest category score is for the category 404-2 “community is OK”, whereas the category 404-n “community should be retired” has a lower score of 9.

In some implementations, the plurality of characteristics may be grouped into one or more groups as illustrated in FIG. 2, for example. In some implementations, assessment tool 132 may generate a group score based on each score for characteristics in a group. In some implementations, assessment tool 132 may generate the group score by adding the characteristic score for each characteristic in the group. In some implementations, the group score may provide an assessment of the technical community based on the group. In other words, the group score may provide an indication of how well a technical community performs in a particular area at a group level. For example, a group score for the “foundational group” may be generated based on the characteristic scores for characteristics in the group. Group scores for the other groups may be similarly generated. In some implementations, group scores may provide community owners with an affinitizing view (groupings based on natural relationships). This may provide a higher level view which may identify the area of best practices that can be leveraged or an area of focus for a respective community.

In some implementations, assessment tool 132 may determine which stage in the community lifecycle the technical community is in based on the score(s). For example, the group scores may be used to determine a stage of the community lifecycle for the community. In some implementations, certain characteristics associated with groups may align/map to the stages of the community lifecycle and may be more relevant at a particular stage. For example, the group score for the “foundational” group and the characteristics associated with the “foundational” group (and/or characteristic scores) may indicate how the community is performing at the “potential” and “coalescing” stages. Similarly, the group score for the “activity” group and the characteristics associated with the “activity” group (and/or characteristic scores) may indicate how the community is performing at the “coalescing” and “maturing” stages. Group scores for the other groups and the respective characteristics may be similarly used to indicate other stages of the community lifecycle that the community may be in. In some implementations, since the group score is a summation of the characteristic scores, the group score may indicate how effective a technical community is at a particular community lifecycle stage. For example, a lower group score may indicate that the technical community is effective at a particular stage. On the other hand, a higher group score may indicate challenges at a particular stage (i.e., the technical community is less effective at a particular stage).

In some implementations, assessment tool 132 may determine which technical community has the potential of moving into a more contributory phase based on the score(s). In some implementations, the determination may be made based on the group score and/or characteristic scores associated with the “knowledge management” group. This is because contribution in a technical organization may come from the “knowledge management” group where ideas translate into product enhancements. The score for the characteristics associated with the “knowledge management” group may directly contribute to the technical organization's product portfolio. For example, technical reach and vitality may translate to product enhancements and contributions. In some implementations, group scores, associated characteristics and their scores for an effective technical community may be analyzed and leveraged for other communities that may be struggling with respect to that group or characteristic.

In some implementations, assessment tool 132 may determine whether the technical community is performing well, is satisfactory, needs repurposing or should be retired based on the category score. In some implementations, assessment tool 132 may determine any remediation that may be applied to the technical community that needs repurposing and/or has areas that need improvement. For example, assessment tool 132 may determine that a skill based technical community scored highest in the category “needs a tune up or repurposing”. Assessment tool 132 may further determine that that “executive sponsorship” and “communications” areas are opportune areas for improvement based on the characteristic score, group score and/or other score(s). Based on the determination, assessment tool 132 may provide a remediation for the technical community, such as, “redefine the program charter aligned with new executive sponsorship”, and “incorporate a robust communications plan leveraging new channels,” for example. In some implementations, assessment tool 132 may determine that a generic development community scored highest in the category “should be retired”. In this case, assessment tool 132 may provide a remediation that may include the retirement of a generic development community that has unclear goals, limited activity and business purpose.

In some implementations, assessment tool 132 may generate one or more reports. In some implementations, the report may include information regarding the characteristics, the categories, the groups, the inputs received from the member of the technical community, the various scores, and/or the assessment made by assessment tool 132. In some implementations, the assessment may i) identify the overall state of the technical community; ii) identify areas of opportunity/improvement within the technical community; iii) identify the stage in the community lifecycle that the technical community resides in; iv) identify whether the technical community has a potential of moving to a more contributory stage in the lifecycle; v) identify whether the technical community is performing well, is satisfactory, needs repurposing or should be retired; and/or vi) identify any remediation.

In some implementations, reports and remediation may be applied to the technical community to sustain or apply continuous improvements.

In some implementations, database 140 may store the various characteristics, categories, groups, assigned weights, and assigned numerical values. In some implementations, database 140 may store the inputs received regarding the characteristics and store reports generated regarding the assessment of the technical community. According to various implementations of the invention, examples of database 140, include, for instance, a relational database, a filesystem, and/or other device or data representation configured for data storage. In some implementations, assessment tool 132 may query database 140 to retrieve the stored information. The lookup may be a structured query language (SQL) query, lightweight directory access protocol (LDAP) query, and/or any other known methods of querying database 140.

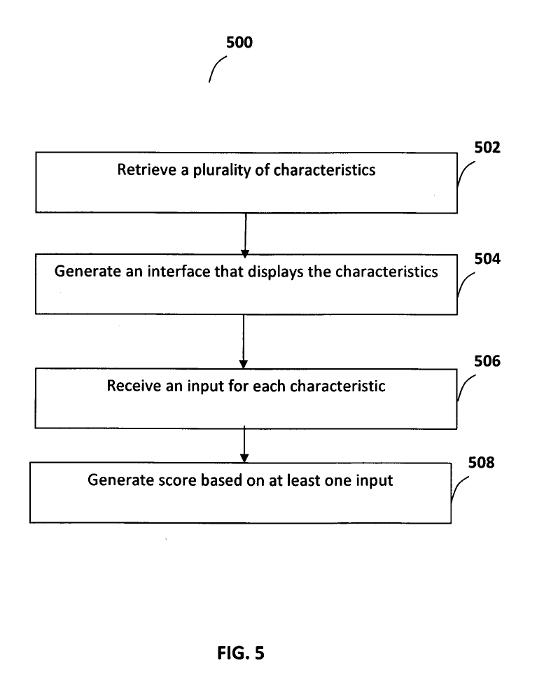

FIG. 5 is a flowchart 500 depicting example operations performed by community management system 130/assessment tool 132 to assess a technical community, according to various aspects of the invention. In some implementations, the described operations may be accomplished using one or more of the modules/components described herein. In some implementations, various operations may be performed in different sequences. In other implementations, additional operations may be performed along with some or all of the operations shown in FIG. 5. In yet other implementations, one or more operations may be performed simultaneously. In yet other implementations, one or more operations may not be performed. Accordingly, the operations described are exemplary in nature and, as such, should not be viewed as limiting.

In an operation 502, process 500 may retrieve a plurality of characteristics that each describe an aspect of the technical community. In some implementations, the plurality of characteristics may be collectively used to assess the technical community.

In an operation 504, process 500 may generate an interface that displays the plurality of characteristics as queries to be answered by a member of the technical community.

In an operation 506, process 500 may receive an input for each characteristic. In some implementations, each input may comprise a quantitative input that provides a qualitative opinion of the member of the technical community for a corresponding characteristic.

In an operation 508, process 500 may generate a score based on at least one input. In some implementations, the score may provide the assessment of the technical community. In some implementations, the score may include a characteristic score for each characteristic. In some implementations, the characteristic score may be based on the input associated with each characteristic. In some implementations, the characteristic score for a characteristic may be based on an assigned weight for the characteristic and a numerical value (associated with a category) that corresponds to the quantitative input for the characteristic. In some implementations, the score may include a category score based on a collection of each of the inputs. In some implementations, the score may include a group score based on each score for characteristics in a group.

Implementations of the invention may be made in hardware, firmware, software, or various combinations thereof. The invention may also be implemented as computer-readable instructions stored on a tangible computer-readable storage medium which may be read and executed by one or more processors. A computer-readable storage medium may include various mechanisms for storing information in a form readable by a computing device. For example, a tangible computer-readable storage medium may include optical storage media, flash memory devices, and/or other storage mediums. Further, firmware, software, routines, or instructions may be described in the above disclosure in terms of specific exemplary aspects and implementations of the invention and performing certain actions. However, it will be apparent that such descriptions are merely for convenience, and that such actions may in fact result from computing devices, processors, controllers, or other devices executing firmware, software, routines or instructions.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method of assessing a technical community, the method comprising:
retrieving, by a processor, a plurality of characteristics that each describe an aspect of the technical community, the technical community comprising a group of members that share expertise regarding a technical subject, wherein the plurality of characteristics are collectively used to assess the technical community;
generating, by the processor, an interface that displays the plurality of characteristics as queries to be answered by a member of the technical community;
receiving, by the processor, an input for each characteristic, wherein each input comprises a quantitative input that provides a qualitative opinion of the member of the technical community for a corresponding characteristic; and
generating, by the processor, a score based on at least one input, wherein the score provides the assessment of the technical community.

2. The method of claim 1, wherein the score comprises a characteristic score for each characteristic, wherein the characteristic score is based on the input associated with each characteristic.

3. The method of claim 2, further comprising:
assigning a weight to each of the plurality of characteristics, wherein the characteristic score is based on the weight.

4. The method of claim 3, further comprising:
assigning a numerical value to each category of a plurality of categories, the numerical value corresponding to the quantitative input;
wherein receiving the input further comprising:
receiving a selection of the numerical value associated with at least one category, wherein the characteristic score is generated based on the weight and the numerical value.

5. The method of claim 1, wherein the score comprises a category score based on a collection of each of the inputs, wherein the category score indicates an overall state of the technical community.

6. The method of claim 1, wherein the plurality of characteristics are grouped into one or more groups, the method further comprising:
generating a group score based on each score for characteristics in a group, wherein the group score provides an assessment of the technical community based on the group.

7. The method of claim 1, further comprising:
determining whether the technical community is performing well, is satisfactory, needs repurposing or should be retired based on the score.

8. The method of claim 1, wherein generating an interface further comprising:
generating an interface that displays each characteristic in a multiple-choice answer format, each multiple choice answer representative of the quantitative input.

9. The method of claim 8, wherein the interface displays a description of each multiple-choice answer, the description describing the qualitative opinion of the member.

10. The method of claim 1, wherein generating an interface further comprising:
generating a tabular representation that displays the plurality of characteristics.

11. A system of assessing a technical community, the system comprising one or more processors configured to:
retrieve a plurality of characteristics that each describe an aspect of the technical community, the technical community comprising a group of members that share expertise regarding a technical subject, wherein the plurality of characteristics are collectively used to assess the technical community;
generate an interface that displays the plurality of characteristics as queries to be answered by a member of the technical community;
receive an input for each characteristic, wherein each input comprises a quantitative input that provides a qualitative opinion of the member of the technical community for a corresponding characteristic; and
generate a score based on at least one input, wherein the score provides the assessment of the technical community.

12. The system of claim 11, wherein the score comprises a characteristic score for each characteristic, wherein the characteristic score is based on the input associated with each characteristic.

13. The system of claim 12, wherein the one or more processors are further configured to:
assign a weight to each of the plurality of characteristics, wherein the characteristic score is based on the weight.

14. The system of claim 13, wherein the one or more processors are further configured to:
assign a numerical value to each category of a plurality of categories, the numerical value corresponding to the quantitative input;
wherein the processors configured to receive the input are further configured to:
receive a selection of the numerical value associated with at least one category, wherein the characteristic score is generated based on the weight and the numerical value.

15. The system of claim 11, wherein score comprises a category score based on a collection of each of the inputs, wherein the category score indicates an overall state of the technical community.

16. The system of claim 11, wherein the plurality of characteristics are grouped into one or more groups, the one or more processors further configured to:
generate a group score based on each score for characteristics in a group, wherein the group score provides an assessment of the technical community based on the group.

17. The system of claim 11, wherein the one or more processors are further configured to:
determine whether the technical community is performing well, is satisfactory, needs repurposing or should be retired based on the score.

18. The system of claim 11, wherein the one or more processors configured to generate an interface are further configured to:
generate an interface that displays each characteristic in a multiple-choice answer format, each multiple choice answer representative of the quantitative input.

19. The system of claim 18, wherein the interface displays a description of each multiple-choice answer, the description describing the qualitative opinion of the member.

20. A tangible computer-readable storage medium having one or more computer-readable instructions thereon which when executed by one or more processors cause the one or more processors to:
retrieve a plurality of characteristics that each describe an aspect of the technical community, the technical community comprising a group of members that share expertise regarding a technical subject, wherein the plurality of characteristics are collectively used to assess the technical community;
generate an interface that displays the plurality of characteristics as queries to be answered by a member of the technical community;
receive an input for each characteristic, wherein each input comprises a quantitative input that provides a qualitative opinion of the member of the technical community for a corresponding characteristic; and
generate a score based on at least one input, wherein the score provides the assessment of the technical community.

21. The tangible computer-readable storage medium of claim 20, wherein the score comprises a characteristic score for each characteristic, wherein the characteristic score is based on the input associated with each characteristic.

22. The tangible computer-readable storage medium of claim 21, wherein the one or more instructions further cause the one or more processors to:
assign a weight to each of the plurality of characteristics, wherein the characteristic score is based on the weight.

23. The tangible computer-readable storage medium of claim 22, wherein the one or more instructions further cause the one or more processors to:
assign a numerical value to each category of a plurality of categories, the numerical value corresponding to the quantitative input;
wherein the instructions causing the processors to receive the input further cause the one processors to:
receive a selection of the numerical value associated with at least one category, wherein the characteristic score is generated based on the weight and the numerical value.

24. The tangible computer-readable storage medium of claim 20, wherein the score comprises a category score based on a collection of each of the inputs, wherein the category score indicates an overall state of the technical community.

25. The tangible computer-readable storage medium of claim 20, wherein the plurality of characteristics are grouped into one or more groups, wherein the one or more instructions further cause the processors to:
generate a group score based on each score for characteristics in a group, wherein the group score provides an assessment of the technical community based on the group.
